(19) United States
(12) Patent Application Publication
(10) Pub. No.: US 2007/0150477 A1
(43) Pub. Date: Jun. 28, 2007

(54) Validating a uniform resource locator ('URL') in a document

(75) Inventors: Eric L. Barsness, Pine Island, MN (US); John M. Santosuosso, Rochester, MN (US)

Correspondence Address: IBM (ROC-BLF), C/O BIGGERS & OHANIAN, LLP, P.O. BOX 1469, AUSTIN, TX, 78767-1469, US

(73) Assignee: INTERNATIONAL BUSINESS MACHINES CORPORATION, ARMONK, NY (US)

(21) Appl. No.: 11/316,248

(22) Filed: Dec. 22, 2005

(51) Int. Cl. G06F 17/30

(52) U.S. Cl. 707/10

(57) ABSTRACT

Validating a URL in a document, including identifying the URL in the document, where the URL identifies a computer resource containing text, the document contains other text in addition to the URL, and the document is under edit by a user in an editing program on a computing device. Embodiments also include analyzing the validity of the URL, including analyzing the proximity of the other text to the URL in the document and comparing the other text in the document to the text in the resource identified by the URL in dependence upon the proximity of the other text to the URL in the document. Embodiments also include advising the user of the validity of the URL.

### BACKGROUND OF THE INVENTION

1. Field of the Invention

The field of the invention is data processing, or, more specifically, methods, apparatus, and products for validating a Uniform Resource Locator (‘URL’) in a document.

2. Description of Related Art

The development of the EDVAC computer system of 1948 is often cited as the beginning of the computer era. Since that time, computer systems have evolved into extremely complicated devices. Today's computers are much more sophisticated than early systems such as the EDVAC. Computer systems typically include a combination of hardware and software components, application programs, operating systems, processors, buses, memory, input/output devices, and so on. As advances in semiconductor processing and computer architecture push the performance of the computer higher and higher, more sophisticated computer software has evolved to take advantage of the higher performance of the hardware, resulting in computer systems today that are much more powerful than just a few years ago.

One of the areas of computer technology that has experienced rapid improvement is text editing. Computer technology now provides text editors for many, many purposes: word processing, editing email messages and instant text messages, web page development, spreadsheet data entry editing, user interfaces for database management systems, text boxes in browsers, and sophisticated source code editing in integrated development environments, just to name a few. Rapid increase is also experienced in the use of the World Wide Web, a computing network that provides convenient access to many computer resources. The resources are located on the World Wide Web by use of Uniform Resource Locators or ‘URLs.’ A URL is a textual representation for the network address of a computer resource and the use of URLs is increasing explosively.

Support for editing URLs in text documents, however, has remaining challenges. URLs do not form dictionary word and therefore cannot be verified with a traditional spell checker. It is possible to make a typographical error in a URL and never know it until some reader tries to access the resource purportedly identified by the URL and fails. It is becoming common for print media errata that include URLs. Here are examples from a recent This Old House magazine:
Directory for Luxuries, “The Envelope, Please,” April: The website address for the “Craftsman Inspired” mailbox should read mountainsedge.ca, not .com.
“A Tale of 4 Cities,” April: On p. 84, the contact or the Dora Moore 2005 House Tour in Denver should be doramoore.dpsk12.org.

### SUMMARY OF THE INVENTION

Methods, apparatus, and computer program products are disclosed for improved validation of a URL in a document that include identifying a URL in a document, where the URL identifies a computer resource containing text, the document contains other text in addition to the URL, and the document is under edit by a user in an editing program on a computing device. Embodiments also include analyzing the validity of the URL, including analyzing the proximity of the other text to the URL in the document and comparing the other text in the document to the text in the resource identified by the URL in dependence upon the proximity of the other text to the URL in the document. Embodiments include advising the user of the validity of the URL.

The foregoing and other objects, features, and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a network diagram illustrating an exemplary system for validating a URL in a document according to embodiments of the present invention.

FIG. 2 sets forth a block diagram of automated computing machinery comprising an exemplary computer useful in validating a URL in a document according to embodiments of the present invention.

FIG. 3 sets forth a flow chart illustrating an exemplary method for validating a URL in a document according to embodiments of the present invention.

FIG. 4 sets forth a flow chart illustrating a further exemplary method for validating a URL in a document according to embodiments of the present invention.

### DETAILED DESCRIPTION OF EXEMPLARY EMBODIMENTS

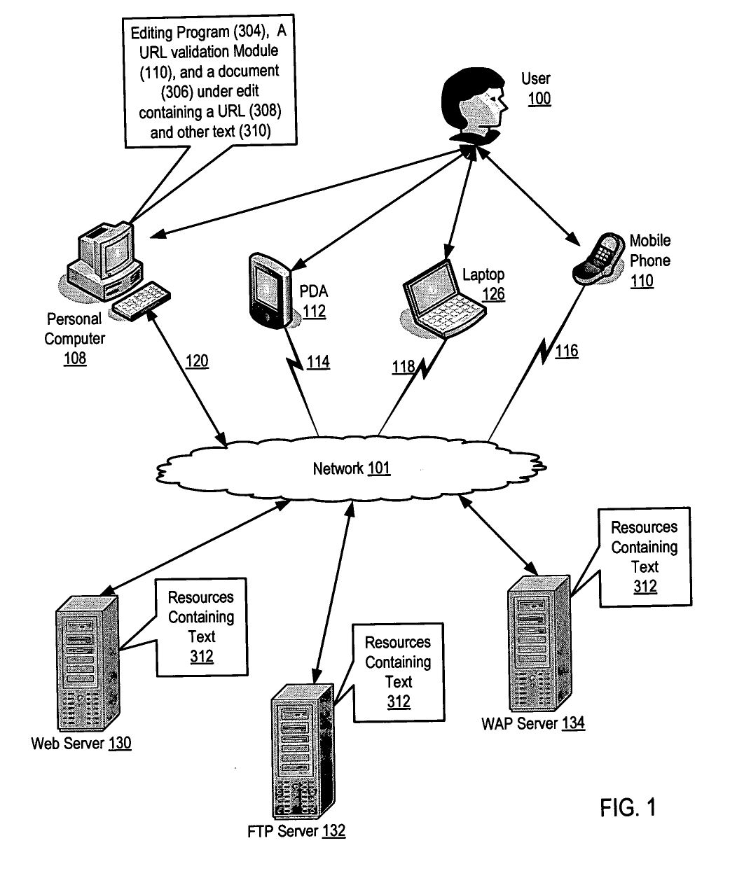

Exemplary methods, apparatus, and products for validating a URL in a document according to embodiments of the present invention are described with reference to the accompanying drawings, beginning with FIG. 1. FIG. 1 sets forth a network diagram illustrating an exemplary system for validating a URL in a document according to embodiments of the present invention. The system of FIG. 1 operates generally to validate a URL in a document according to embodiments of the present invention by identifying a URL (308) in a document (306), analyzing the validity of the URL, and advising a user (100) of the validity of the URL. The URL identifies a computer resource (312) containing text, the document contains other text in addition to the URL, and the document is under edit by a user in an editing program (304) on a computing device. The system of FIG. 1 operates generally to analyze the validity of the URL by analyzing the proximity of other text to the URL in the document and comparing, in dependence upon the proximity of the other text to the URL in the document, the other text in the document to the text in the resource identified by the URL. The system of FIG. 1 validates URLs by a URL validation module (110).

In this specification ‘computer resource’ or ‘resource’ refers to any aggregation of information identified by a URL and containing a text. In fact, the ‘R’ in ‘URL’ (Uniform Resource Locator) stands for ‘resource.’ Network communications protocols generally, for example, HTTP, TCP/IP, and so on, transmit resources, not just files. The most common kind of resource is a file, but resources include dynamically-generated query results as well, such as the output of CGI (‘Common Gateway Interface’) scripts, output from JSPs (Java Server Pages), other dynamic server pages, documents available in several languages, and so on. In effect, a resource is somewhat similar to a file, but more general in nature. As a practical matter, most resources are currently either files or server-side script output. Server-side script output includes output from CGI programs, Java servlets, Active Server Pages, Java Server Pages, and so on.

The system of FIG. 1 includes several examples of computing devices capable of operating to validate URLs according to embodiments of the present invention, including a personal computer (108), a personal digital assistant (112), a laptop computer (126), and a mobile telephone (110). These are examples only; any device capable of operating according to stored computer program instructions may be adapted to validate URLs according to embodiments of the present invention.

The system of FIG. 1 includes several servers that provide resources (312) containing text. A URL is an identifier that resolves to a network address of a computer resource. Resources so identified may include HTML (HyperText Markup Language) pages, static or dynamic, from an HTTP (HyperText Transfer Protocol) server (130). Such resources may include files bearing text from an FTP (File Transfer Protocol) server (132). Such resources may include WML (Wireless Markup Language) pages from a WAP (Wireless Access Protocol) server (134). And so on—for any computer resource containing text. The servers (130, 132, 134) in the system of FIG. 1 may be any computer capable of accepting a request for a resource and responding by providing the resource to the requester. One example of such a server is an HTTP (‘HyperText Transport Protocol’) server or ‘web server.’

The example of FIG. 1 includes network (101) which connects computer devices (108, 112, 126, 110) that validate URLs according to embodiments of the present invention with servers (130, 132, 134) that provide resources (312) containing text. The resources (312) containing text are resources identified by URLs (308) to be validated. The arrangement of computing devices, networks, servers, and other devices making up the exemplary system illustrated in FIG. 1 are for explanation, not for limitation. Data processing systems useful according to various embodiments of the present invention may include additional servers, routers, other devices, and peer-to-peer architectures, not shown in FIG. 1, as will occur to those of skill in the art. Networks in such data processing systems may support many data communications protocols, including for example TCP (Transmission Control Protocol), IP (Internet Protocol), HTTP (HyperText Transfer Protocol), WAP (Wireless Access Protocol), HDTP (Handheld Device Transport Protocol), and others as will occur to those of skill in the art. Various embodiments of the present invention may be implemented on a variety of hardware platforms in addition to those illustrated in FIG. 1.

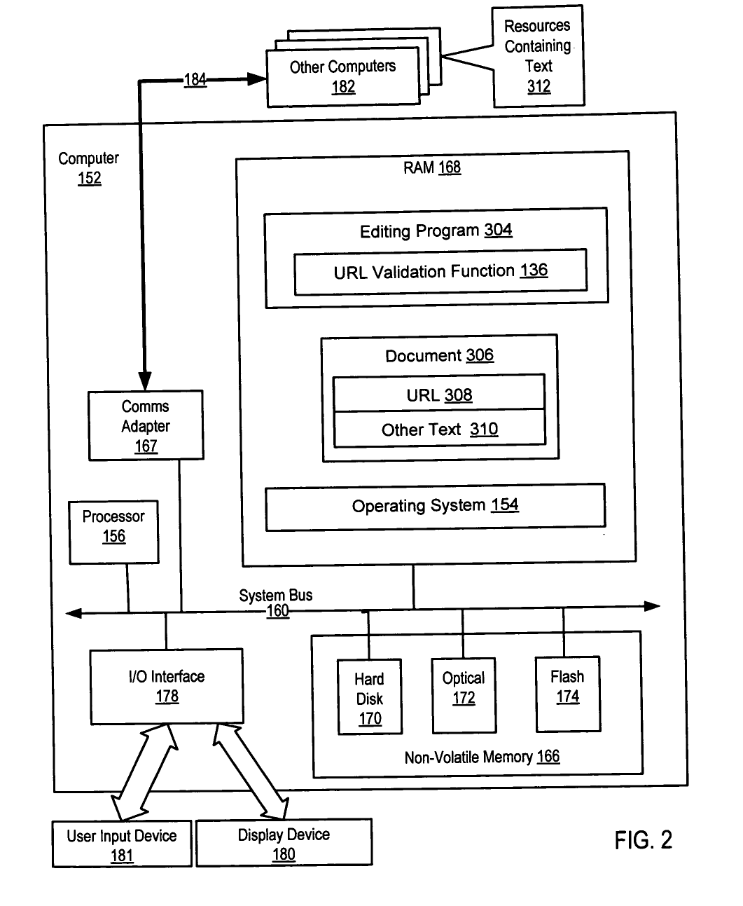

Validating a URL in a document in accordance with the present invention is generally implemented with computers, that is, with automated computing machinery. In the system of FIG. 1, for example, all the computer devices, networks, and servers are implemented to some extent at least as computers. For further explanation, therefore, FIG. 2 sets forth a block diagram of automated computing machinery comprising an exemplary computer (152) useful in validating a URL in a document according to embodiments of the present invention. The computer (152) of FIG. 2 includes at least one computer processor (156) or ‘CPU’ as well as random access memory (168) (‘RAM’) which is connected through a system bus (160) to processor (156) and to other components of the computer.

Stored in RAM (168) is an editing program (304), a module of computer program instructions for editing a document containing text. An editing program useful for validating URLs according to embodiments of the present invention is any computer program that can edit any document containing text, including, for example, word processing programs such as Microsoft Word™, source code editors in Integrated Development Environments, message editors in email client programs such as Microsoft Outlook™, and markup language editors in web page development tools Macromedia Dreamweaver™.

Also stored in RAM is a URL validation function (136), a computer software module made up of computer program instructions that operate generally to validate a URL according to embodiments of the present invention by identifying a URL (308) in a document (306), analyzing the validity of the URL, and advising a user of the validity of the URL. Such a URL validation function may be invoked by a user through a user interface to validate URLs as part of a spell checking function or a grammar checking function in the editing program (304). Or such a URL validation function may be invoked by a user independently to validate URLs. Alternatively, such a URL function may be configured to operate continuously in background to validate URLs as a user types them into document (306) through editing program (304).

Also stored in RAM is a document (306) under edit containing a URL (308) and other text (310). The URL itself is text, so the term ‘other text’ is used to distinguish the URL from the text surrounding the URL in the document. There is no requirement that the document under edit contain only text; the document under edit may contain binary control codes, for example, and proprietary codes or other data in addition to text. The text may be implemented in any representation of text, ASCII, EBCDIC, Unicode, and so on.

Also stored in RAM (168) is an operating system (154). Operating systems useful in computers according to embodiments of the present invention include UNIX™, Linux™, Microsoft XP™, AIX™, IBM's i5/OS™, and others as will occur to those of skill in the art. Operating system (154), editing program (304), URL validation function (136), and document (306) in the example of FIG. 2 are shown in RAM (168), but many components of such software typically are stored in non-volatile memory (166) also.

Computer (152) of FIG. 2 includes non-volatile computer memory (166) coupled through a system bus (160) to processor (156) and to other components of the computer (152). Non-volatile computer memory (166) may be implemented as a hard disk drive (170), optical disk drive (172), electrically erasable programmable read-only memory space (so-called ‘EEPROM’ or ‘Flash’ memory) (174), RAM drives (not shown), or as any other kind of computer memory as will occur to those of skill in the art.

The example computer of FIG. 2 includes one or more input/output interface adapters (178). Input/output interface adapters in computers implement user-oriented input/output through, for example, software drivers and computer hardware for controlling output to display devices (180) such as computer display screens, as well as user input from user input devices (181) such as keyboards and mice.

The exemplary computer (152) of FIG. 2 includes a communications adapter (167) for implementing data communications (184) with other computers (182). In typical embodiments of the present invention, resources containing text (312) as identified by a URL (308) are located on such other computers, such as servers connected through a network to a computing device with a document under edit. Data communications with such other computers may be carried out serially through RS-232 connections, through external buses such as USB, through data communications networks such as IP networks, and in other ways as will occur to those of skill in the art. Communications adapters implement the hardware level of data communications through which one computer sends data communications to another computer, directly or through a network. Examples of communications adapters useful for validating a URL according to embodiments of the present invention include modems for wired dial-up communications, Ethernet (IEEE 802.3) adapters for wired network communications, and 802.11b adapters for wireless network communications.

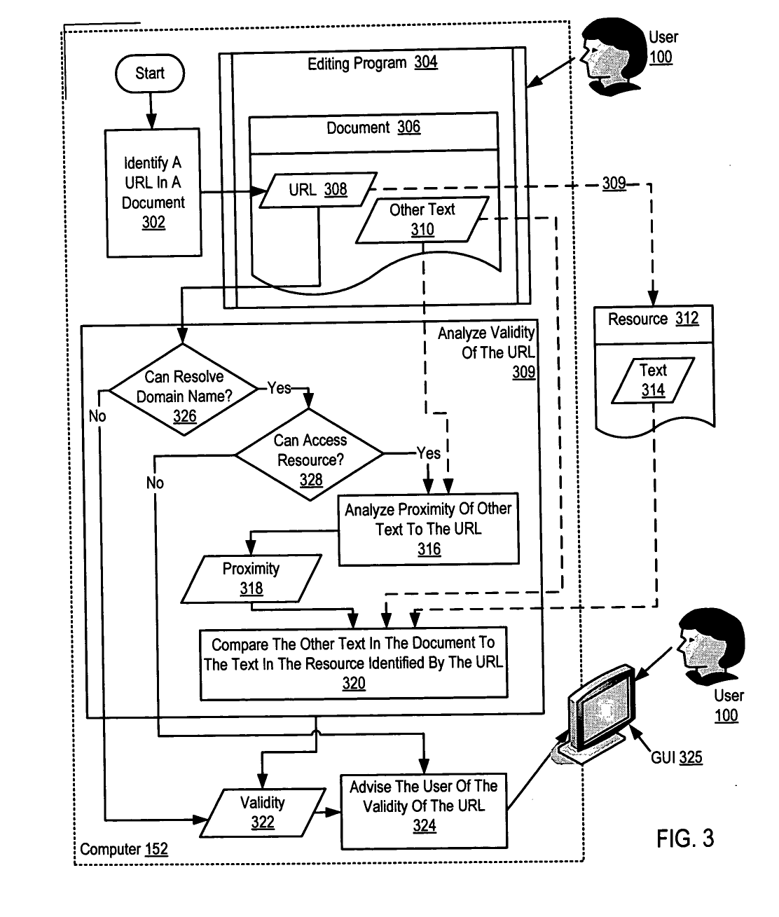

For further explanation, FIG. 3 sets forth a flow chart illustrating an exemplary method for validating a URL in a document according to embodiments of the present invention that includes identifying (302) a URL (308) in a document (306), where the URL identifies (309) a computer resource (312) containing text (314), the document (306) contains other text (310) in addition to the URL, and the document is under edit by a user (100) in an editing program (304) on a computing device (152). One way identifying (302) a URL (308) in a document (306) includes scanning the document for markup language elements consistent with hyperlinks. An anchor element is an example of a markup language element that identifies and implements a hyperlink. A common example form of an anchor element is:
<a href=“http://www.ibm.com”> Press Here For IBM </a>

This example anchor element includes a start tag <a>, and end tag </a>, an href attribute that identifies the target of the link as a web page identified by the URL http://www.ibm.com and an anchor. The “anchor” is the display text that is set forth between the start tag and the end tag. In this example, the anchor is the text “Press Here For IBM.” The “anchor element” is the entire markup from the start tag to the end tag. Because hyperlinks are often used in markup documents to invoke URLs, scanning the markup document for markup language elements consistent with hyperlinks advantageously provides a vehicle for identifying a URL within a markup document.

Another way of identifying (302) a URL (308) in a document includes scanning the document for the individual components of a URL. Consider for example the following URL:
http://www.ibm.com/cgi/calendar.cgi
The component “http://” of this example URL is called a ‘scheme.’ The scheme designates a communications protocol for the URL. The component “www.ibm.com” of the URL is called the ‘host.’ The host identifies a machine running a web server. The host can be a domain name or an IP address. Because IP addresses often change, hosts are often implemented with domain names. The component “cgi/calendar.cgi” of the exemplary URL is called a ‘path’ and identifies the location of the resource being requested, such as an HTML file or a CGI script. While the combination of individual components of URLs may vary from URL to URL, many components are common to many URLs. For example, the scheme “http://” is common to URLs using the HyperText Transfer Protocol. Identifying (302) a URL (308) in a document (306) therefore may be carried out by scanning the document for URL schemes, host components, and paths. Other methods of identifying a URL in a document will occur to those of skill in the art, and all such methods are well within the scope of the present invention.

The method of FIG. 3 also includes analyzing (309) the validity of the URL. In the example of FIG. 3, analyzing the validity (309) of the URL includes analyzing (316) the proximity of the other text to the URL in the document and comparing (320) the other text (310) in the document (306) to the text (314) in the resource (312) identified by the URL in dependence upon the proximity of the other text to the URL in the document. Proximity may be analyzed by specifying proximity of text in terms of the organization of the text within the document, words, sentences, paragraphs, pages, and so on. Proximity of text with respect-to the URL may be specified for example by:
specifying a proximity for words within the same sentence as the URL;
specifying a proximity for words within the same paragraph as the URL, where the specified proximity for words in the same paragraph but not in the same sentence with the URL is less than the proximity for words in the same sentence with the URL;
specifying a proximity for words in the same page with as the URL, where the specified proximity for words in the same page but not in the same paragraph with the URL is less than the proximity for words in the same paragraph with the URL;
specifying a proximity for words within N words of the URL, where N is any integer;
specifying a proximity for words within N+M words of the URL, where N and M are integers, and the specified proximity for words within N+M words of the URL is less than the specified proximity for words within N words of the URL;
And so on . . .

In the method of FIG. 3, analyzing (316) the proximity of the other text to the URL in the document may be carried out by giving greater weight to words in close proximity to the URL. One way to give greater weight to words in close proximity to the URL is to count the words in the document, specify a proximity for each word as described just above, and then weight the counts of the words according to each word's proximity. In this way, a word that occurs five times in the document with three of the occurrences in the same sentence with the URL may be given greater weight than a word that occurs seven times with no occurrences in the same sentence with the URL, for example.

In the method of FIG. 3, comparing (320) the other text in the document to the text in the resource identified by the URL may be carried out by giving greater weight to words in close proximity to the URL. That is, words occurring in the resource identified by the URL that also occur in the document with the URL may be given greater weight in comparison according to each word's proximity to the URL in the document. This may be accomplished by counting the words in the resource (312) that also occur in the document (306), specifying a proximity with respect to the URL for each word that occurs both in the document (306) and in the resource (312), and then weighting the counts of the words according to each word's proximity to the URL in the document. In this way a word that occurs five times in the resource with three occurrences in the same sentence with the URL in the document may be given greater weight than a word that occurs seven times in the resource with no occurrences in the same sentence with the URL in the document, for example.

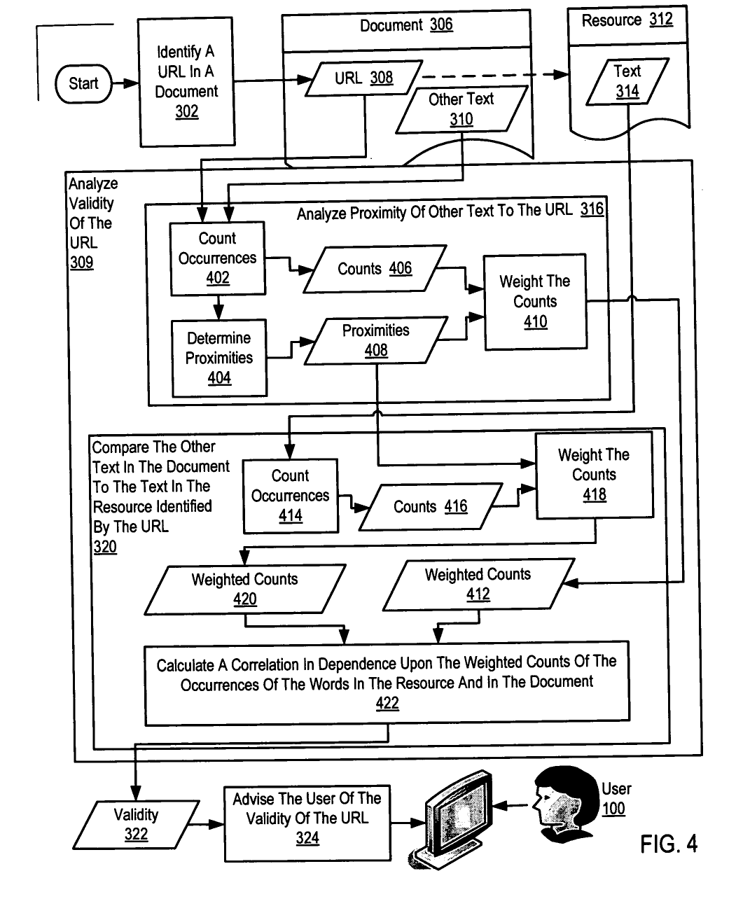

In the method of FIG. 3 and as described in more detail below with reference to FIG. 4, analyzing the validity of the URL may be carried out by calculating, in dependence upon weighted counts of occurrences of words in the resource and the document, a correlation for occurrences of words in the resource and the same words in the document. The term ‘correlation’ as it is used in this specification refers to a statistical correlation, also called a ‘correlation coefficient.’ It is a numeric measure of the strength of linear relationship between two random variables. Examples of such random variable useful for validating URLs according to embodiments the present invention include:
a integer value representing a count of the number of time words occur in a document containing a URL, the integer value weighted according to the proximity of the words with respect to the URL, and
a integer value representing a count of the number of time words occur in a resource identified by a URL, where the URL is contained in a document with other text, and this integer value is weighted according to the proximity of the words with respect to the URL in the document.

In general statistical usage, correlation or co-relation refers to the departure of two variables from independence. In this broad sense, there are several coefficients of correlation, measuring the degree of correlation, adapted to the nature of data. The best known is the Pearson product-moment correlation coefficient, which is found by dividing the covariance of the two variables by the product of their standard deviations. Pearson's correlation coefficient is a so-called parametric statistic, however, which works best when the values of the variables it correlates occur in known, parameterized distributions. Pearson's correlation may be less useful for variables in non-parameterized distributions, and the present inventors are unaware of any reason to believe that frequency counts of words will lie in parameterized distributions. Non-parametric correlation methods, such as Spearman's ρ and Kendall's τ, therefore may be preferred for validating URLs according to embodiments of the present invention.

The method of FIG. 3 also includes advising (324) the user of the validity (322) of the URL. Measures of validity (322) may be relative or absolute. Validity measured by correlation, for example, may be relative. In the method of FIG. 3, advising the user of the validity of the URL may be carried out by advising the user of the validity of the URL in dependence upon a calculated correlation for occurrences of words in the resource and the same words in the document. Advising of validity in dependence upon such a correlation is an example of a relative measure of validity. A correlation may have a value between −1 and +1 where a positive value of the correlation indications that ranks of two correlated variables increase together—and are therefore said to be ‘positively correlated’ A negative correlations is one in which the ranks of one variable increase as the ranks of the other variable decrease, a ‘negative correlation.’ A correlation of exactly −1 or +1 will arise if the relationship between the two variables is exactly linear. A correlation close to zero means there is no particular relationship between the two variables. One way to specify a relative measure of validity for a URL is to calculate a correlation between word frequencies in a document and a resource weighted according to proximity to a URL in the document and specify the validity in terms of the correlation: highly valid if the correlation is greater than 0.8, very valid if between 0.6 and 0.8, somewhat valid if between 0.4 and 0.6, and invalid if less than 0.4.

Measures of validity (322) also may be absolute. In the method of FIG. 3, analyzing the validity of the URL also may include determining (326) whether a domain name in the URL can be resolved. The Domain Name System (“DNS”) is a name service typically associated with the Internet. The DNS translates domain names into network addresses. To resolve a domain name contained in the URL, a system routine called a ‘resolver’ accessible to a URL validation function of the present invention submits a query to a DNS name server containing the domain name identified in the URL. DNS includes a request/response data communications protocol with standard message types for resolving domain names. Gethostbyname( ) and InetAddress.getByName( ) are two examples of resolver API calls useful in resolving domain names that invoke a TCP/IP client in an operating system such as Unix or Windows. Such a TCP/IP client typically bears one or more predesignated DNS server addresses, designations of a primary DNS server for a computer and possibly one or more secondary DNS servers. In response to a call to a resolver function such as gethostbyname( ) and InetAddress.getByName( ), a TCP/IP client sends a DNS request message containing the domain name in a standard format to a predesignated primary DNS server requesting a corresponding network address. The DNS name server “resolves” the domain name to an IP address and sends the IP address back to the resolver as the “answer” to the query. The resolver passes the IP address to the calling URL validation function.

Determining (326) whether a domain name in the URL can be resolved therefore is an example of an absolute measure of validity because if the domain name cannot be resolved, no resource identified by the URL can be retrieved for analysis, and no determination regarding validity can be made. In the method of FIG. 3, if the domain name can be resolved, processing continues with a determination whether the resource identified by the URL can be accessed. If the domain name cannot be resolved, the validity (322) of the URL is reported as ‘invalid,’ and the user (100) is so advised.

The method of FIG. 3 also includes advising (324) the user of the validity of the URL in dependence upon whether (328) the computer is presently capable of accessing the resource identified by the URL. The resource may be unavailable for access for several reasons, network failure, no present network connection from computing device (152) to the network, the server where the resource is located may be down temporarily, and so on. Such unavailability of the resource identified by the URL for analysis tells nothing regarding the validity of the URL. Advising (324) the user of the validity in this circumstance therefore means advising the user that no determination of validity has been made and that the user may re-invoke the URL validation function later to try again to validate the URL.

Advising (324) the user of the validity (322) of the URL (308) is generally carried out by displaying a message to the user (100) through user interface (325) of computing device (152). The user interface may be text-based or it may be a graphical user interface (‘GUI’). The message may be displayed on a command line of a command line interface (‘CLI’) or in a dialogue box of a GUI, for example. Also, because a URL may be validated while the user types, advising the user of the validity of the URL also may be carried out by highlighting the URL as displayed on a computer display screen while the URL is typed into the document. The URL may be displayed in bold or underlined to indicate validity. Or the URL may be displayed in one color to indicate validity and another color to indicate invalidity, blue and red respectively, for example.

For further explanation, FIG. 4 sets forth a flow chart illustrating a further exemplary method for validating a URL in a document according to embodiments of the present invention. The method of FIG. 4 is similar to the method of FIG. 3. That is, the method of FIG. 4 includes identifying (302) a URL (308) in a document (306), analyzing (309) the validity of the URL, and advising (324) the user of the validity of the URL, all of which have functions similar to those described above regarding the method of FIG. 3. In addition, in the method of FIG. 4, like the method of FIG. 3, analyzing (309) the validity of the URL (308) includes analyzing (316) the proximity of the other text to the URL in the document and comparing (320) the other text (310) in the document (306) to the text (314) in the resource (312) identified by the URL in dependence upon the proximity of the other text to the URL in the document.

In the method of FIG. 4, however, analyzing (316) the proximity of the other text (310) to the URL (308) includes counting (402) the occurrences of words in the document, determining (404) for each word in the document a proximity (408) to the URL, and weighting (410) the counts (406) of occurrences of words in the document in dependence upon the proximity (408) of the words in the document to the URL. In addition in the method of FIG. 4, comparing (320) the other text (310) in the document (306) to the text (314) in the resource (312) identified by the URL includes counting (414) the occurrences of words in the resource that are also in the document, weighting (418) the counts (416) of occurrences of words in the resource in dependence upon the proximity (408) of the words to the URL in the document, and calculating (422) a correlation (322) in dependence upon the weighted counts (420, 412) of the occurrences of the words in the resource (312) and in the document (306). In this example, the correlation is taken as an indication of the validity (322) of the URL.

Consider for example the following document containing a URL and other text:
Pearson's correlation coefficient is a parametric statistic, and it may be less useful if the underlying assumption of normality is violated. Additional information regarding parametric statistics may be found at http://en.wikipedia.org/wiki/Parametric_statistics. Non-parametric correlation methods, such as Spearman's ρ and Kendall's τ may be useful when distributions are not normal.

In this example, the URL is “http://en.wikipedia.org/wiki/Parametric_statistics,” and the other text is all the text in the document except the URL. In this example, analyzing (316) the proximity of the other text (310) to the URL (308) includes counting (402) the occurrences of words in the document, determining (404) for each word in the document a proximity (408) to the URL, and weighting (410) the counts (406) of occurrences of words in the document in dependence upon the proximity (408) of the words in the document to the URL may be carried out as illustrated in Table 1. This example disregards word such as ‘a,’ ‘be,’ ‘it,’ ‘at,’ and so on, which have little or no semantic content:

TABLE 1

| | | | Weighted |
|---|---|---|---|
| Word | Count | Proximity | Count |
| pearson | 1 | 30 | 6 |
| correlation | 2 | 29, 2: 15 | 12 |
| coefficient | 1 | 28 | 6 |
| parametric | 3 | 25, 6, 1: 11 | 13 |
| statistic | 2 | 24, 5: 15 | 12 |
| normal | 2 | 12, 14: 13 | 12 |
| spearman | 1 | 5 | 16 |
| kendall | 1 | 7 | 16 |

In this example, proximities are assigned according to the number of words separating a word from the URL. Proximities for words having more than one occurrence in the document are calculated by averaging word-separation proximities for each occurrence. The weighted counts are calculated by adding 5 to the count for each word having a proximity between 1 and 10, 10 to the count for each word having a proximity between 11 and 20, and 15 to the count for each word having a proximity between 21 and 30.

Extend the current example by taking the following as the text (314) of a resource (312) identified by the URL (308):
Parametric inferential statistical methods are mathematical procedures for statistical hypothesis testing which assume that the distributions of the variables being assessed belong to known parameterized families of probability distributions. In that case we speak of a parametric model.

In this example, counting (414) the occurrences of words in the resource that are also in the document and weighting (420) the counts of occurrences of words in the resource in dependence upon the proximity of the words to the URL in the document may be carried out as illustrated in Table 2, again disregarding common words with little or no semantic content:

TABLE 1

| | Count In | Proximity To | Weighted |
|---|---|---|---|
| Words Also In | Resouce | URL In | Count In |
| Document | Text | Document | Resource Text |
| pearson | 0 | 30 | 0 |
| correlation | 0 | 29, 2: 15 | 0 |
| coefficient | 0 | 28 | 0 |
| parametric | 3 | 25, 6, 1: 11 | 13 |
| statistic | 2 | 24, 5: 15 | 12 |
| normal | 0 | 12, 14: 13 | 0 |
| spearman | 0 | 5 | 0 |
| kendall | 0 | 7 | 0 |

In this example, the process of comparing (320) the other text (310) in the document (306) to the text (314) in the resource (312) identified by the URL, which includes counting (414) the occurrences of words in the resource that are also in the document and weighting (420) the counts of occurrences of words in the resource in dependence upon the proximity of the words to the URL in the document, may be completed by using to Spearman's rank correlation coefficient to calculate (422) a correlation in dependence upon the weighted counts of the occurrences of the words in the resource (312) and in the document (306). The Spearman's rank correlation coefficient Rₛ may be calculated as follows:
rank both sets of data from the highest to the lowest.
subtract the two sets of ranks to get the difference d;
square the values of d;
add the squared values of d to get Sigma d²; and
calculate Rₛ=1−(6 Sigma d²/n³−n) where n is the number of ranks.

Readers will recognize in view of the explanations set forth above in this specification that the benefits of validating a URL in a document according to embodiments of the present invention include:
the ability to advise a user that a URL is absolutely invalid because it cannot be resolved to any network address—in effect it identifies nothing, and
the ability to advise a user that a URL is relatively invalid—it identifies a resource, but it probably identifies the wrong resource.

Exemplary embodiments of the present invention are described largely in the context of a fully functional computer system for validating a URL in a document. Readers of skill in the art will recognize, however, that the present invention also may be embodied in a computer program product disposed on signal bearing media for use with any suitable data processing system. Such signal bearing media may be transmission media or recordable media for machine-readable information, including magnetic media, optical media, or other suitable media. Examples of recordable media include magnetic disks in hard drives or diskettes, compact disks for optical drives, magnetic tape, and others as will occur to those of skill in the art. Examples of transmission media include telephone networks for voice communications and digital data communications networks such as, for example, Ethernets™ and networks that communicate with the Internet Protocol and the World Wide Web. Persons skilled in the art will immediately recognize that any computer system having suitable programming means will be capable of executing the steps of the method of the invention as embodied in a program product. Persons skilled in the art will recognize immediately that, although some of the exemplary embodiments described in this specification are oriented to software installed and executing on computer hardware, nevertheless, alternative embodiments implemented as firmware or as hardware are well within the scope of the present invention.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method for validating a Uniform Resource Locator (‘URL’) in a document, the method comprising:
identifying a URL in a document, the URL identifying a computer resource containing text, the document containing other text in addition to the URL;
analyzing the validity of the URL, including analyzing the proximity of the other text to the URL in the document and comparing the other text in the document to the text in the resource identified by the URL in dependence upon the proximity of the other text to the URL in the document; and
advising the user of the validity of the URL.

2. The method of claim 1 wherein:
analyzing the proximity of the other text to the URL in the document includes giving greater weight to words in close proximity to the URL; and
comparing the text in the document to the text in the resource identified by the URL includes giving greater weight to words in close proximity to the URL.

3. The method of claim 1 wherein:
analyzing the proximity of the other text to the URL further comprises counting the occurrences of words in the document and weighting the counts of occurrences of words in the document in dependence upon the proximity of the words in the document to the URL; and
comparing the other text in the document to the text in the resource identified by the URL further comprises counting the occurrences of words in the resource that are also in the document, weighting the counts of occurrences of words in the resource in dependence upon the proximity of the words to the URL in the document, and calculating a correlation in dependence upon the weighted counts of the occurrences of the words in the resource and in the document.

4. The method of claim 1 wherein:
analyzing the validity of the URL further comprises calculating, in dependence upon weighted counts of occurrences of words in the resource and the document, a correlation for occurrences of words in the resource and the same words in the document; and
advising the user of the validity of the URL further comprises advising the user of the validity of the URL in dependence upon the correlation.

5. The method of claim 1 wherein analyzing the validity of the URL further comprises determining whether a domain name in the URL can be resolved.

6. The method of claim 1 wherein advising the user of the validity of the URL is carried out in dependence upon whether the computer is presently capable of accessing the resource identified by the URL.

7. An apparatus for validating a URL in a document, the apparatus comprising a computer processor and a computer memory operatively coupled to the computer processor, the computer memory having disposed within it computer program instructions capable of:
identifying a URL in a document, the URL identifying a computer resource containing text, the document containing other text in addition to the URL;
analyzing the validity of the URL, including analyzing the proximity of the other text to the URL in the document and comparing the other text in the document to the text in the resource identified by the URL in dependence upon the proximity of the other text to the URL in the document; and
advising the user of the validity of the URL.

8. The apparatus of claim 7 wherein:
analyzing the proximity of the other text to the URL in the document includes giving greater weight to words in close proximity to the URL; and
comparing the text in the document to the text in the resource identified by the URL includes giving greater weight to words in close proximity to the URL.

9. The apparatus of claim 7 wherein:
analyzing the proximity of the other text to the URL further comprises counting the occurrences of words in the document and weighting the counts of occurrences of words in the document in dependence upon the proximity of the words in the document to the URL; and
comparing the other text in the document to the text in the resource identified by the URL further comprises counting the occurrences of words in the resource that are also in the document, weighting the counts of occurrences of words in the resource in dependence upon the proximity of the words to the URL in the document, and calculating a correlation in dependence upon the weighted counts of the occurrences of the words in the resource and in the document.

10. The apparatus of claim 7 wherein:
analyzing the validity of the URL further comprises calculating, in dependence upon weighted counts of occurrences of words in the resource and the document, a correlation for occurrences of words in the resource and the same words in the document; and
advising the user of the validity of the URL further comprises advising the user of the validity of the URL in dependence upon the correlation.

11. The apparatus of claim 7 wherein analyzing the validity of the URL further comprises determining whether a domain name in the URL can be resolved.

12. The apparatus of claim 7 wherein advising the user of the validity of the URL is carried out in dependence upon whether the computer is presently capable of accessing the resource identified by the URL.

13. A computer program product for validating a URL in a document, the computer program product disposed upon a signal bearing medium, the computer program product comprising computer program instructions capable of:
identifying a URL in a document, the URL identifying a computer resource containing text, the document containing other text in addition to the URL;
analyzing the validity of the URL, including analyzing the proximity of the other text to the URL in the document and comparing the other text in the document to the text in the resource identified by the URL in dependence upon the proximity of the other text to the URL in the document; and
advising the user of the validity of the URL.

14. The computer program product of claim 13 wherein the signal bearing medium comprises a recordable medium.

15. The computer program product of claim 13 wherein the signal bearing medium comprises a transmission medium.

16. The computer program product of claim 13 wherein:
analyzing the proximity of the other text to the URL in the document includes giving greater weight to words in close proximity to the URL; and
comparing the text in the document to the text in the resource identified by the URL includes giving greater weight to words in close proximity to the URL.

17. The computer program product of claim 13 wherein:
analyzing the proximity of the other text to the URL further comprises counting the occurrences of words in the document and weighting the counts of occurrences of words in the document in dependence upon the proximity of the words in the document to the URL; and
comparing the other text in the document to the text in the resource identified by the URL further comprises counting the occurrences of words in the resource that are also in the document, weighting the counts of occurrences of words in the resource in dependence upon the proximity of the words to the URL in the document, and calculating a correlation in dependence upon the weighted counts of the occurrences of the words in the resource and in the document.

18. The computer program product of claim 13 wherein:
analyzing the validity of the URL further comprises calculating, in dependence upon weighted counts of occurrences of words in the resource and the document, a correlation for occurrences of words in the resource and the same words in the document; and
advising the user of the validity of the URL further comprises advising the user of the validity of the URL in dependence upon the correlation.

19. The computer program product of claim 13 wherein analyzing the validity of the URL further comprises determining whether a domain name in the URL can be resolved.

20. The computer program product of claim 13 wherein advising the user of the validity of the URL is carried out in dependence upon whether the computer is presently capable of accessing the resource identified by the URL.
